(19) United States
(12) Patent Application Publication
(10) Pub. No.: US 2018/0328410 A1
(43) Pub. Date: Nov. 15, 2018

(54) LUBRICATION OF GEARS IN TWIN-SHAFT PUMPS

(71) Applicant: Edwards Limited, Burgess Hill (GB)

(72) Inventor: Nigel Paul Schofield, Burgess Hill (GB)

(21) Appl. No.: 15/975,208

(22) Filed: May 9, 2018

(30) Foreign Application Priority Data
May 10, 2017 (GB) 1707458.4

(51) Int. Cl. F16C 33/66; F16N 7/12; F04D 29/053; F04D 19/04; F04D 29/063

(52) U.S. Cl. CPC F16C 33/6648; F16C 33/6659; F16N 7/12; F16C 2360/45; F04D 29/053; F04D 19/042; F04D 29/063; F16C 33/6685

(57) ABSTRACT

A twin-shaft pump comprising: two shafts configured to rotate in synchronisation, each of the shafts comprising a gear mounted thereon, the gears each comprising gear wheels, the gear wheels being configured to intermesh to provide the synchronised rotation; an oil reservoir comprising a porous material, the reservoir being configured when supplied with oil to retain the oil within the porous material; and at least one wick extending from the oil reservoir towards a first of the two shafts and operable to supply oil by capillary action from the porous material along the wick to lubricate the gears.

### FIELD OF THE INVENTION

The invention relates to the field of pumps and in particular twin-shaft pumps where the two shafts rotate in a synchronised manner.

### BACKGROUND

Where a pump has two shafts it is important that they are synchronised with each other. Although timing gears can be used to ensure that the shafts rotate in a synchronised manner, this can be problematic in dry vacuum pumps for example where it is important to protect the vacuum from contamination by oil.

In the high vacuum/scientific market, very small screw pumps typically 10 m/hr which run at speeds of 20,000 to 30,000 rpm are sometimes used. A key feature of these pumps is their very small size and lack of any oil in the system. Their small size makes them prone to being tilted or turned upside down during transport or indeed in use. This leads to the use of oil as a lubricant being potentially problematic. However, their high speed of operation means that any gearing without oil lubrication can lead to difficulties. Lubricating gears with grease is not effective at high speeds. One solution to this has been to time the shafts magnetically and drive them with two motor rotors, one on each shaft. The bearings in such a machine are all grease lubricated, and there are no gears. A potential problem with timing the shafts magnetically is that it is complicated, relatively expensive, and the pump is prone to seizure if the pump is roughed.

It would be desirable to find a different solution to shaft synchronisation that would work for small, high speed machines.

### SUMMARY

A first aspect provides a twin-shaft pump comprising: two shafts configured to rotate in synchronisation, each of said shafts comprising a gear mounted thereon, said gears each comprising gear wheels, said gear wheels being configured to intermesh to provide said synchronised rotation; an oil reservoir comprising a porous material, said reservoir being configured when supplied with oil to retain said oil within said porous material; and at least one wick extending from said oil reservoir towards a first of said two shafts and operable to supply oil by capillary action from said porous material along said wick to lubricate said gears.

The inventor of the present invention recognised that although there was a technical prejudice against using oil within some pumps such that the use of timing gears to synchronise twin-shafts becomes problematic, one solution to this m might be, rather than finding an alternative to gears, finding a way of constraining the oil. In this way oil may be used to lubricate while avoiding or at least reducing any “free” oil present within the pump. Problems associated with oil leakage into different parts of the pump during transport or use can then be avoided or at least reduced. In this regard the inventor recognised that the use of some sort of porous material within an oil reservoir would allow the oil to be held within the pores of the material and avoid or at least reduce any oil leaking from the reservoir even were the reservoir to be tipped or inverted. Furthermore, although gears require effective lubrication such that free oil is generally used, it is found that the supply of oil by a wick is sufficient for effective lubrication as it is aided by the high speed of rotation and furthermore the supplied oil migrates to the required lubrication location that is towards the intermeshing surfaces of the gears.

A porous material such as a sponge or felt type material within a reservoir along with some wicking material to bring the oil from the reservoir to the components requiring lubrication and in particular to gears mounted on the twin-shafts, would provide both lubrication and a way of constraining oil leakage allowing the twin shafts of a twin-shaft pump to be synchronised and operated at a high speed.

In some embodiments, said at least one wick extends to contact a surface of at least one of: said first shaft and said gear mounted on said first shaft.

In order to transfer the oil from the reservoir to lubricate the gear, the wick may extend to contact a surface of the shaft or a surface of the gear itself. The surface of the gear may be the gear hub or the gear wheel. The oil will then migrate towards the teeth of the gear being thrown outwards towards these teeth in operation by centrifugal force due to the rotation of the shaft and gear.

In some embodiments, said at least one wick extends to contact a tapered surface having a diameter that increases towards said gear wheel of said gear mounted on said first shaft, rotation of said first shaft causing said tapered surface to rotate and exerting a centrifugal force on oil contacting said tapered surface and causing said oil to migrate from said at least one wick along said increasing diameter surface towards said gear wheel.

In order to improve the transport of the oil a tapered surface may be used whose diameter increases towards the gear wheel of the gear. In this way, oil that contacts this tapered surface will be driven by centrifugal force along the increasing diameter towards the gear wheel. In effect the rotation of the shafts is used to provide a force on the oil to draw it from a wick along the shaft towards the lubrication site making this an effective means of lubricating while still constraining oil migration or leakage along other paths. The higher the speed of rotation the higher the centrifugal force pulling the oil, thus this solution has the additional advantage of providing lubrication which improves with speed of rotation.

Although the gears mounted on the two shafts may in some embodiments be aligned with each other, in some embodiments one gear overlaps on at least one side with respect to the other.

In some embodiments, said gear mounted on a second of said two shafts is arranged to extend in an axial direction beyond said gear on said first shaft in a direction towards said wick extending towards said first shaft.

Overlap of one of the gears with respect to the other provides a way of catching oil flung from the edge of one gear wheel and helps not only provide lubrication to a further gear wheel without a direct wick, but also reduces the amount of oil migrating to unwanted parts of the machine in use. In this regard although the reservoir and porous material provides a very effective way of holding the oil in place when the pump is not in use and in particular, in transport, once the oil reaches a rotating surface it will migrate towards an outer surface and at least some of the oil will be flung off the outer surface. Providing the overlap makes use of this and provides an effective way of lubricating one gear wheel from another, while also reducing unwanted free oil in the system.

This overlap may be achieved by mounting the gears with an offset with respect to each other or it might be achieved by having different sized gear wheels. In either case one overlaps the end of the other one on at least one side. Where the oil is being supplied to only one of the gears, then it will be forced by centrifugal force towards the outer circumference of the gear wheel of that gear and some will be flung off the outer edge of that gear wheel. If there is an overlapping gear wheel, then it will be in the path of the oil being thrown from the gear wheel and lubrication of the second gear wheel from the first gear wheel can be effectively performed without supplying oil by a wick to the second shaft or gear.

In some embodiments, said wick is arranged to extend towards a portion of said first shaft on a side of said gear wheel remote from said pumping chamber. While in other embodiments, said wick is arranged to extend towards a portion of said first shaft on a same side of said gear wheel as said pumping chamber.

The wick may be arranged to extend towards a portion of the first shaft, either on the same side of the gear wheel as the pumping chamber of on the far side.

In some embodiments, there is a wick that extends to either side of the gear wheel. In such a case, there may be a tapered surface on both sides of the gear wheel and thus the oil is effectively supplied to both sides of the gear wheel which may improve lubrication.

In some embodiments, said gear wheel mounted on said second shaft is thicker than said gear wheel mounted on said first shaft and extends beyond said gear wheel mounted on said first shaft on both sides.

Although in some embodiments the gear wheels mounted on both shafts have the same thickness, in some embodiments the gear wheel mounted on the second shaft may be thicker than the gear wheel mounted on the first shaft. Where the wick supplies oil just to the first shaft, then as noted previously, an overlap with the gear wheel on the other shaft allows oil to be effectively supplied to that gear wheel. If the gear wheel overlaps on both sides, then this may be particularly advantageous where the pump comprises a wick extending from the oil reservoir towards the shaft on both sides of the gear wheel. In this case both sides of the gear wheel are substantially equally lubricated and the second gear wheel picks up oil thrown by centrifugal force from both sides of the gear wheel mounted on the first shaft.

In some embodiments, said pump comprises a further wick extending from said oil reservoir towards said second of said two shafts, said wick and said further wick being configured to supply oil to said gears mounted on said respective shafts.

Although the gears may be lubricated by simply supplying oil to one of the gears mounted on one of the shafts, in some embodiments, there may be a wick extending towards both shafts such that oil is supplied via wicks to both gears.

In some cases, and in particular where one of the gear wheels is offset with respect to the other, then the wicks extending towards both shafts extend towards them on either side of the gear wheels. In this way, the gear wheel that provides the overlap on one side is the gear wheel that is not being supplied with oil from a wick on that side. Thus oil flung from the edge of the lubricated gear wheel will more easily contact the overlapping gear wheel mounted on the other shaft.

In some embodiments, said pump comprises two further wicks extending from said oil reservoir towards said second of said two shafts, said two further wicks extending towards said second shaft on either side of said gear wheel.

In some cases, the gears on both shafts may be lubricated from both sides and a plurality of further wicks may be used.

In some embodiments, the pump comprises two further wicks, said respective two further wicks extending towards each of said shafts and being operable to supply oil by capillary action from said porous material along said wicks to lubricate bearings in which said shafts are mounted.

Where an oil reservoir is used to lubricate the gear wheels then it may be advantageous if this lubrication system is also used to lubricate the bearings. In this regard, bearings may be lubricated with grease to provide lubrication which does not allow free oil to be present in the system, however in some cases where an oil reservoir with a porous material is used, then additional wicks can supply oil from this reservoir to the bearings and they can be lubricated in the same way as the gears, to provide an effective and cost efficient lubrication.

In some embodiments, said pump comprises a tapered surface on each of said shafts, said tapered surface having a diameter that increases towards said bearings, said two further wicks extending to contact said tapered surfaces.

To provide more effective lubrication of the bearings using this wicking system, a tapered surface is advantageous with an increasing diameter towards the bearings such that centrifugal forces help transport the oil towards the bearings.

In some embodiments, in operation of the pump said shafts are substantially horizontal and said oil reservoir is mounted below said first and said second shaft and an opening in said reservoir through which said wick extends is in an upper surface of said reservoir.

Although the twin shaft pump may be one with vertical shafts, in some embodiments it comprises shafts that are substantially horizontal when in operation and in such a case, the oil reservoir is mounted so that its surface from which the wick extends is an upper surface below the two shafts. Where the shafts are vertically mounted in use then the oil reservoir opening from which the wick extends is in a surface perpendicular to, below and facing towards the shafts. Mounting the oil reservoir below the shafts allows any oil flung from the gear wheels during operation to drain back into the reservoir.

In some embodiments, said twin-shaft pump comprises a vacuum pump.

In some embodiments, the vacuum pump comprises a screw pump while in other embodiments it comprises a multi-stage roots pump.

In still other embodiments, the pump comprises a compressor.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION OF THE DRAWINGS

Embodiments of the present invention will now be described further, with reference to the accompanying drawings, in which:

FIG. 1 illustrates a twin-shaft pump according to an embodiment;

FIG. 2 illustrates the shafts, gear wheels and oil reservoir of an embodiment; and

FIG. 3 illustrates the shafts, gear wheels and oil reservoir of a further embodiment.

### DESCRIPTION OF THE EMBODIMENTS

Before discussing the embodiments in any more detail, first an overview will be provided.

Twin shaft pumps and in particular, vacuum pumps such as screw pumps and multi stage roots pumps require the shafts to be synchronised. Where the pumps are for example, high vacuum pumps that are sensitive to oil contamination and operate at high speeds, then alternatives to timing gears have been used to avoid the need to lubricate these gear wheels.

In this regard, gears require oil lubrication if they are to operate for more than a few hours at high speed. Grease lubrication of gears is only suitable for low speed or short run times. Dry running gears also have a very limited operational life and are not suitable for such applications.

This problem has been addressed in a low cost, simple and yet effective manner in embodiments of the invention. The solution involves the use of timing gears moubted on the shafts lubricated by oil supplied to the gears from a porous material within a reservoir via a wick.

Embodiments use a felt reservoir to hold oil within the felt, the oil then being fed to the gears via a wick system. This provides sufficient lubrication for the gears to operate at high speed and avoids the need for any ‘free’ oil in a gearbox.

In this way, oil is provided to the gears while avoiding free oil within the pump by using a wick to feed oil from a felt reservoir onto a tapered portion of the shaft. The oil migrates up the taper due to centrifugal force. A gear is located at the end of the taper section and the oil migrates onto this gear and then spreads to the perimeter where it lubricates the teeth.

Provision of oil in this way allows the pump to be shipped and perhaps even operated at any angle without issues of oil draining out of the gearbox into the pump mechanism.

FIG. 1 schematically shows a pump according to an embodiment, where twin shafts 10, 20 rotate driving interlocking rotors (not shown) within pumping chamber 70.

The two shafts 10, 20 extend beyond pumping chamber 70 on either side and are rotationally mounted by bearings 80. Timing gears 60 are mounted towards one end of both first shaft 10 and second shaft 20 and interlock via teeth 63 on the two gear wheels 62. This interlocking forces the shafts to rotate in synchronisation with each other and allows only one of the shafts to be directly driven, the other rotating in response to rotation of the driven shaft.

Lubrication of gears 60 is provided by oil from oil reservoir 30 which contains a porous material (not shown) such as felt. This oil is wicked from the reservoir 30 by wick 40 which extends from the oil reservoir 30 to a tapered conical surface 50 mounted on the first shaft 10. This tapered surface might be a part of the gear 60, such as the gear hub, or it may be a separate component mounted on shaft 10, or it may be machined into the shaft.

The oil is pulled by capillary action along wick 40 onto surface 50. The spinning of surface 50, when the pump is operational, pulls oil by centrifugal force along the increasing diameter of cone 50 to gear wheel 62. The oil migrates to the outer surface of this gear wheel and lubricates the interlocking teeth. Some of the oil is flung from the outer surface of the gear wheel 62 and due to the overlap of gear wheel 62 mounted on the second shaft 20 at an offset to gear wheel 62 on the first shaft 10, some of this oil is directed onto the overlapping surface and serves to help lubricate the gear wheel 62 on the second shaft 20. Any oil not “caught” by the gear wheel 62 on the second shaft 20 drains back into the reservoir. In this way both gear wheels are effectively lubricated by a single wick.

In this embodiment the gear wheels are at the high vacuum or inlet end of the vacuum pump where the pressure is generally sub-atmospheric. This reduces the effect of windage or air drag from disturbing the wick and the oil migration. In other embodiments, the gear wheels may be mounted on the atmospheric or exhaust end and this may also be effective depending on operational conditions.

In the embodiment of FIG. 1 first shaft 10, is shown as mounted below second shaft 20, this is purely for ease of illustration and in general the two shafts will be mounted side by side. The two shafts are mounted above an oil reservoir 30 such that oil flung from the gear wheels on either shaft will drain back into the oil reservoir. The shafts can be arranged in a different manner, they may for example be mounted as schematically shown that is one on top of the other or in a vertical orientation. In each case the oil reservoir 30 will be located beneath the shafts such that the wick 40 extends out of an upper surface of the reservoir 30 as is shown.

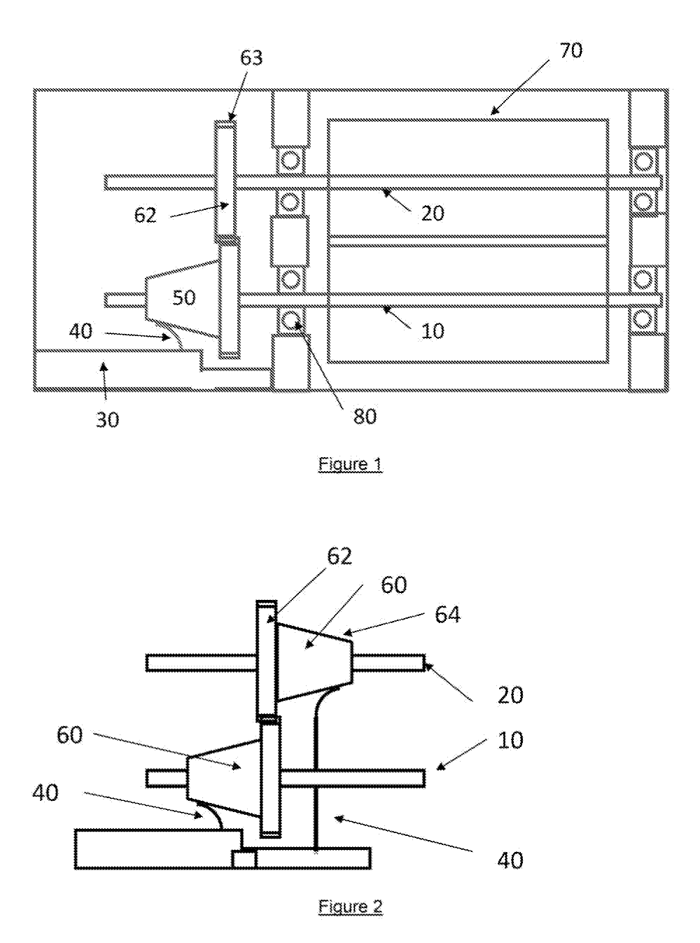

FIG. 2 shows an embodiment similar to that of FIG. 1 but with an additional wick 40 which extends towards the second shaft 20. In this embodiment each of the two wicks contacts a tapered surface which in this embodiment is the tapered hub 64 of the gears 60. This additional wick 40 means that the gear wheel 62 mounted on the second shaft 20 receives oil via a wick from the reservoir and not just from the gear wheel 62 mounted on the first shaft. This may improve lubrication. By supplying oil to the opposite side of the gear wheel, the offset mounting of the two gear wheels provides an overlap on the wick side for each gear wheel not directly lubricated by a wick on this side. Thus, oil flung from the lubricated side of each gear wheel will be directed towards the overlapping surface of the other gear wheel. In this embodiment as for FIG. 1 the shafts are mounted side by side although they are shown as one on top of the other for ease of illustration.

In other embodiments not shown, the two gear wheels may be aligned. In such an embodiment, one of the gear wheels may be lubricated by a wick or they may both be lubricated independently using wicks extending to tapered surfaces on both shafts. In some cases, oil will be supplied to either side of the gear wheels and both gear wheels will be lubricated from both sides.

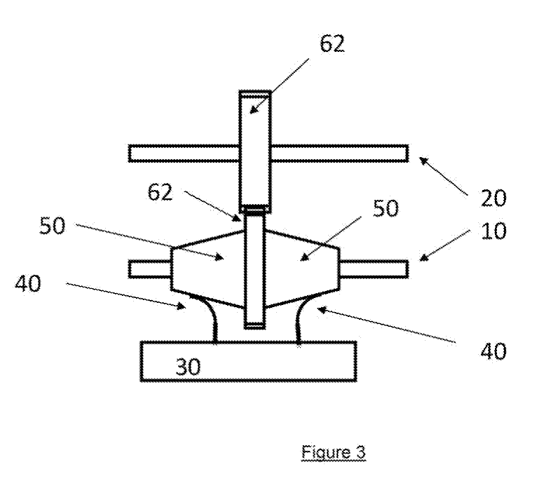

FIG. 3 schematically shows a further embodiment, where the gear wheel 62 on the first shaft 10 is narrower than the gear wheel 62 on the second shaft 20, such that the gear wheel on the second shaft extends beyond the gear wheel 62 on the first shaft 10 on both sides. In this embodiment, two wicks 40 extend to tapered surfaces 50 on either side of the gear wheel 62 on the first shaft 10. Oil is thereby supplied to either side of the gear wheel 62 on the first shaft 10 and in operation rotation of this gear wheel causes oil to migrate to the outer surface and some of the oil to be flung from the outer surface and be received by the overlapping surfaces of gear wheel 62 on the second shaft 20, such that this thicker gear wheel is lubricated from oil supplied to the thinner gear wheel.

In summary, embodiments use an oil felt reservoir to lubricate the gears of a twin shaft vacuum pump, such as a screw pump or multi stage roots pump. The bearings may be grease lubricated, although in some embodiments these too are lubricated using the oil felt reservoir system. The advantage of this system is that there is no free oil in the pump that could drain into the pump mechanism if the pump is turned upside down say in transit.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

### REFERENCE SIGNS

10 first shaft

20 second shaft

30 oil reservoir

40 wick

50 cone shaft extension

60 gear

62 gear wheel

63 gear teeth

64 gear hub

70 pump chamber

80 bearings

1. A twin-shaft pump comprising:
two shafts configured to rotate in synchronisation, each of said shafts comprising a gear mounted thereon, said gears each comprising gear wheels, said gear wheels being configured to intermesh to provide said synchronised rotation;
an oil reservoir comprising a porous material, said oil reservoir being configured when supplied with oil to retain said oil within said porous material; and
at least one wick extending from said oil reservoir towards a first of said two shafts and operable to supply oil by capillary action from said porous material along said wick to lubricate said gears.

2. The twin-shaft pump according to claim 1, wherein said at least one wick extends to contact a surface of at least one of: said first shaft and said gear mounted on said first shaft.

3. The twin-shaft pump according to claim 1, wherein said at least one wick extends to contact a tapered surface having a diameter that increases towards said gear wheel of said gear mounted on said first shaft, rotation of said first shaft causing said tapered surface to rotate and exerting a centrifugal force on oil contacting said tapered surface and causing said oil to migrate from said at least one wick along said increasing diameter surface towards said gear wheel.

4. The twin-shaft pump according to claim 1, wherein said gears mounted on said two shafts are offset with respect to each other.

5. The twin-shaft pump according to claim 1, wherein said gear mounted on a second of said two shafts is arranged to extend in an axial direction beyond said gear on said first shaft in a direction towards said wick extending towards said first shaft.

6. The twin-shaft pump according to claim 1, wherein said wick is arranged to extend towards a portion of said first shaft on a side of said gear wheel remote from a pumping chamber of said pump.

7. The twin-shaft pump according to claim 1, wherein said wick is arranged to extend towards a portion of said first shaft on a same side of said gear wheel as a pumping chamber of said pump.

8. The twin-shaft pump according to claim 6 when dependent on any one of claims 1 to 3, said pump comprising a further wick, said further wick extending towards said first shaft on a same side of said gear wheel as said pumping chamber.

9. The twin-shaft pump according to claim 8, said gear wheel mounted on said second shaft being thicker than said gear wheel mounted on said first shaft and extending beyond said gear wheel mounted on said first shaft on both sides of said gear wheel.

10. The twin-shaft pump according to claim 1, said pump comprising a further wick extending from said oil reservoir towards said second of said two shafts, said wick and said a further wick being configured to supply oil to said gears mounted on said respective shafts.

11. The twin-shaft pump according to claim 10, wherein one of said wick and said further wick is arranged to extend towards a portion of one of said shafts on a same side of said gear wheel as said pumping chamber and the other of said wick and said further wick is arranged to extend towards a portion of the other shaft on a side of said gear wheel remote from said pumping chamber.

12. The twin-shaft pump according claim 8, said pump comprising two further wicks extending from said oil reservoir towards said second of said two shafts, said two further wicks extending towards said second shaft on either side of said gear wheel.

13. The twin-shaft pump according to claim 1, said pump comprising two further wicks, respective ones of said further wicks extending towards each of said shafts and operable to supply oil by capillary action from said porous material along said wicks to lubricate bearings in which said shafts are mounted.

14. The twin-shaft pump according to claim 13, said pump comprising a tapered surface on each of shafts, said tapered surface having a diameter that increases towards said bearings, said two further wicks extending to contact said tapered surfaces.

15. The twin-shaft pump according to claim 1, wherein in operation said shafts are substantially horizontal and said oil reservoir is mounted below said first shaft and an opening in said reservoir through which said wick extends is in an upper surface of said reservoir.

16. The twin-shaft pump according to claim 1, wherein said twin-shaft pump comprises a vacuum pump.

17. The twin-shaft pump according to claim 16, wherein said vacuum pump comprises a screw pump.

18. The twin-shaft pump according to claim 16, wherein said vacuum pump comprises a multi-stage roots pump.

19. The twin-shaft pump according to claim 1, wherein said pump comprises a compressor.
